(19) United States
(12) Patent Application Publication
(10) Pub. No.: US 2010/0062818 A1
(43) Pub. Date: Mar. 11, 2010

(54) REAL-TIME INTERACTION WITH A VIRTUAL COMPETITOR WHILE PERFORMING AN EXERCISE ROUTINE

(75) Inventors: Allen P. Haughay, JR., San Jose, CA (US); Jeffrey T. Lee, San Jose, CA (US); Irvin W. Graves, JR., Sunnyvale, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/207,126

(22) Filed: Sep. 9, 2008

(51) Int. Cl. G06F 17/00; A63B 71/00

(52) U.S. Cl. 463/7; 482/8

(57) ABSTRACT

A portable electronic device for providing real-time interaction between a user performing an exercise routine and a virtual competitor. Some embodiments of the portable electronic device may include a sensor for receiving a plurality of user performance metrics associated with the user, a processor for generating a comparison between the plurality of user performance metrics and a competitor workout file associated with the virtual competitor, and a display for displaying a summary of the comparison in real-time.

### FIELD OF THE INVENTION

The invention relates generally to interactive fitness systems and methods and, more particularly, to providing real-time interaction between a user performing an exercise routine and a virtual competitor.

2. Background of the Disclosure

Fitness enthusiasts sometimes need new sources of motivation, such as when training indoors during inclement weather. Modern health clubs partly serve this need by providing television monitors and music to entertain members using treadmills, stationary bicycles, elliptical trainers, and other fitness equipment. Products like the Nike+iPod Sports Kit provide workout-based voice feedback, motivational media, and the ability to share workouts among Nike+community members. Some individuals, however, want a more interactive and engaging experience while exercising.

### SUMMARY OF THE DISCLOSURE

Embodiments of the invention relate to a portable electronic device for providing real-time interaction between a user performing an exercise routine and a virtual competitor. Some embodiments of the portable electronic device may include a sensor for receiving a plurality of user performance metrics associated with the user, a processor for generating a comparison between the plurality of user performance metrics and a competitor workout file associated with the virtual competitor, and a display for displaying a summary of the comparison in real-time.

Other embodiments of the invention relate to a portable electronic device for providing real-time interaction between a user performing an exercise routine and a virtual competitor. An exemplary portable electronic device may include a network interface for receiving a workout file associated with the virtual competitor and for receiving a plurality of performance metrics associated with the user. The portable electronic device may also include a user input device for receiving an instruction to play the workout file and an output module for playing media associated with the plurality of performance metrics associated with the user and the workout file associated with the virtual competitor.

Other embodiments of the invention relate to a network server, e.g., a web server, for facilitating communications among a plurality of electronic devices over a network to implement a real-time interactive application. An exemplary web server may include an input module for receiving from a first electronic device a first plurality of performance metrics associated with a first user and for receiving from a second electronic device a second plurality of performance metrics associated with a second user. The device may also include an output module for causing a display associated with the first electronic device to display graphics associated with the second plurality of performance metrics and for causing a display associated with the second electronic device to display graphics associated with the first plurality of performance metrics.

Other embodiments of the invention relate to a portable electronic device for providing interactive game play between a user performing an exercise routine and a virtual competitor. An exemplary portable electronic device may include a sensor input for receiving a plurality of performance metrics associated with the user, an output module for displaying a user avatar associated with the user and for displaying a competitor avatar associated with the virtual competitor, and a user input device configured to receive commands to control the user avatar. In some embodiments, the competitor avatar may be responsive to the movement of the user avatar.

Another embodiment of the invention relates to a system for providing interactive game play between a user performing an exercise routine and a virtual competitor. An exemplary system may include a portable electronic device configured to detect a plurality of user performance metrics associated with the exercise routine. In some embodiments, the portable electronic device may be configured to receive a user input during the exercise routine. The system may also include a computer, in communication with the portable electronic device, configured to generate a comparison between the plurality of user performance metrics and a plurality of virtual competitor performance metrics and to display a visualization of the comparison. In some embodiments, the visualization may include an avatar associated with the user and responsive to user input.

### BRIEF DESCRIPTION OF THE DRAWINGS

The above and other aspects and advantages of the invention will become more apparent upon consideration of the following detailed description, taken in conjunction with the accompanying drawings, in which like reference numerals refer to like parts throughout, and in which:

FIG. 1 is a simplified functional block diagram of a portable electronic device in accordance with some embodiments of the invention;

FIG. 2 is a simplified functional block diagram of a system for sharing information stored in a remote database according to some embodiments of the invention;

FIG. 3 is a schematic diagram of an exemplary system for providing real-time interaction between a user and a virtual competitor according to some embodiments of the invention;

FIG. 4 is a process diagram of an exemplary method for providing real-time interaction between a user performing an exercise routine and a virtual competitor; according to some embodiments of the invention;

FIG. 5 is a schematic diagram of an exemplary system for providing real-time interaction between multiple users performing an exercise routine over a network according to some embodiments of the invention; and

FIG. 6 is a schematic diagram of an exemplary system for providing real-time interaction between a user performing an exercise routine and a virtual competitor using a hands-free mouse according to some embodiments of the invention.

### DETAILED DESCRIPTION OF THE DISCLOSURE

Embodiments of the invention relate to a system and method for providing real-time interaction between a user performing an exercise routine and a virtual competitor. For example, some embodiments relate to a portable electronic device that receives performance metrics from a user running on a treadmill and displays real-time graphics relating to the user's performance metrics on a display along with a competitor's performance metrics.

In the following discussion of illustrative embodiments, the term “performance metrics” encompasses metrics indicative of the amount or quality of a fitness activity that a user has performed. For example, performance metrics can include physiological metrics (e.g., heart rate, EKG, blood oxygen content, temperature, heat flux, etc.) and non-physiological indications of performance (e.g., distance covered, pace, etc.). The term “real-time” refers to an approximate correspondence of a media output with the actual time in which events are taking place. The approximation depends, in part, on the speed of the users' respective computing devices, the speed of the network connection, the amount of traffic load on the computing system and other variables known to cause delay in the transmission of data via the Internet or other networks. The terms “workout file” and “workout data” are used interchangeably to refer to any information associated with an individual performing an exercise routine including, but not limited to, performance metrics. The workout file may be generated in a variety of formats, or combinations of formats, including markup language, such as XML. The terms “coupled to” or “in communication with,” refer to, without limitation, any connection or coupling, either direct or indirect, between two or more elements whether physical, logical, or a combination of both.

It is to be understood that the figures and descriptions of the invention have been simplified to illustrate elements that are relevant for a clear understanding of the invention while eliminating, for purposes of clarity, other elements. For example, details relating to signal processing within a portable electronic device such as digital circuitry, analog circuitry, and software for amplifying and filtering data signals from sensors are not described herein. Similarly, certain details relating to the implementation of an interactive application between multiple users over a wide area network, are not described herein. A discussion of these elements is not provided because they are well known in the art and because they do not facilitate a better understanding of the invention.

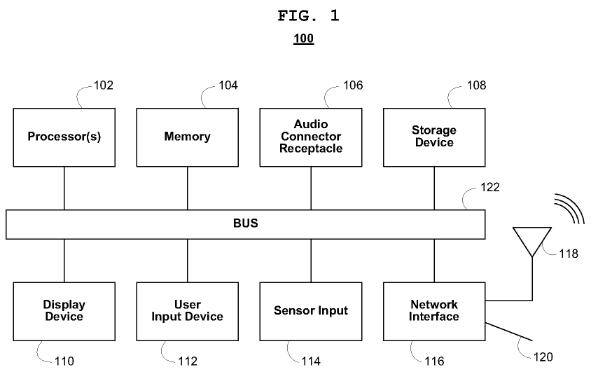

FIG. 1 shows a simplified functional block diagram of a portable electronic device 100 according to an illustrative embodiment of the invention. Electronic device 100 includes a processor 102, a memory 104, an audio connector receptacle 106, a storage device 108, a display device 110, a user input device 112, a sensor input 114, a network interface 116, an antenna 118, and a network cable 120, all coupled, either directly or indirectly, to a system bus 122. The systems and methods described herein may be implemented on a variety of portable electronic devices including the iPod and iPhone available from Apple Computer, Inc. of Cupertino, Calif.

Processor 102 may be a processor, ASIC, circuit, or any combination thereof. Processor 102 can, for example, control operation of electronic device 100, generate audio signals for transmission to a headset, instruct audio signals to be transmitted to a headset, generate control signals for and/or accept data signals from sensors for detecting performance metrics. While electronic device 100 is illustrated with a single processor, those skilled in the art will appreciate that a portable electronic device may include multiple processors and/or co-processors.

Memory 104 can include read only memory (ROM), random access memory (RAM), solid-state memory, buffer memory, hard drive memory, any other memory known in the art or otherwise, or any combination thereof. In some embodiments, memory 104 can store sensor data generated by sensor 114, and/or any other sensor used for tracking a user's performance metrics. In other embodiments, memory 420 also can store workout files for playback by electronic device 100. Workout files can include, for example, audio files for playback through speakers or a headset and/or graphic images for playback on a display (e.g., display 110). The workout files can include media files that a user has selected to be played back during performance of an exercise routine to entertain and motivate the user. Such media files can include, for example, songs, audio books, multimedia presentations, still images, text, podcasts, videos, etc.

Audio connector receptacle 106 can be configured to accept an audio connector, such as a headset. In some embodiments of the invention, the audio connector and receptacle 106 can transmit control signals to and accept data from sensors integrated with a headset via a dedicated electrical lead in the audio connector.

Storage device 108 may include one or more non-volatile storage mediums, including for example, a hard-drive, flash memory, permanent memory such as ROM, semi-permanent memory such as RAM, or cache. In some embodiments, storage device 108 tangibly embodies programs, functions, and/or instructions that cause the portable electronic device to operate in a specific and predefined manner as described herein. As those skilled in the art will appreciate, FIG. 1 may include software that acts as an intermediary between users and the basic resources of portable electronic device 100. Those skilled in the art will also appreciate that the invention can be implemented with various operating systems or combinations of operating systems.

Storage device 108 may also store media (e.g., music and video files), preference information (e.g., media playback preferences), lifestyle information (e.g., food preferences), exercise information (e.g., information obtained by exercise monitoring equipment including workout files), transaction information (e.g., information such as credit card information), wireless connection information (e.g., information that may enable media device to establish wireless communication with another device), subscription information (e.g., information that keeps tracks of podcasts or television shows or other media a user subscribes to), and any other suitable data.

Display 110 may be configured to provide graphics (e.g., text, still images, and/or videos) to the user. In some embodiments of the invention, display 110 can provide the user with graphics about the user's performance metrics and the performance metrics of a competitor, either from workout files stored in memory 104, downloaded from a remote database, or streamed from a data network via antenna 118 or a host device. In some embodiments of the invention, processor 102 can instruct display 110 to display simultaneously graphics about the user's performance metrics and a virtual competitor's performance metrics.

User input device 112 may be configured to allow a user to interact with electronic device 100. User input component 112 may include a clickwheel similar to that incorporated in some models of iPods. The clickwheel can include one or more buttons and a touchpad. The touchpad can permit a user to scroll by running the user's finger around the track of the clickwheel. In alternative embodiments, user input device 112 can include, for example, one or more buttons, a touchpad, a touchscreen display, electronics for accepting voice commands, antennas for accepting signals from other electronic devices, infrared ports for accepting signals from other electronic devices, or any combination thereof. Display 110 and user input 112 can be integrated into one component by using a touchscreen display.

Sensor input 114 can be any device that can detect the user's performance metrics. Sensor input 114 may be coupled to pedometers, devices having accelerometers, heart rate monitors, oximeters, location-tracking (e.g., GPS) devices, devices having temperature sensors, devices having heat flux sensors, electrocardiogram devices, scales, glucometer devices, devices having activity tracking sensors, any other suitable tracking device useful for capturing data about a person's activities, any other suitable tracking device useful for capturing data about a person's physical or mental state, or any combination thereof. Suitable sensors are described in U.S. Patent Application Publication No. 20080076972, published on Mar. 27, 2008, the entirety of which is incorporated by reference.

Network interface 116 may provide access to a network, such as a local area network. Network interface 116 may include, for example, a wireless network interface having antenna 118, which may represent one or more antennae, for wirelessly communicating with a data network and/or with one or more accessories (e.g., a headset). For example, electronic device 100 can include one or more antennas for communication with a Bluetooth-enabled device, a WiFi network, a cellular network, a radio network, or any combination thereof. In some embodiments of the invention, antenna 118 can permit a user to stream or otherwise download data from a server.

Network interface 116 may also include, for example, a wired network interface to communicate with remote devices via network cable 120, which may be, for example, an Ethernet cable, a coaxial cable, a fiber optic cable, a serial cable, or a parallel cable.

These are representative components of a portable electronic device whose operation is well understood. Furthermore, those of ordinary skill in the art will appreciate that the portable electronic device illustrated herein is exemplary only and that the invention can operate within a number of different configurations.

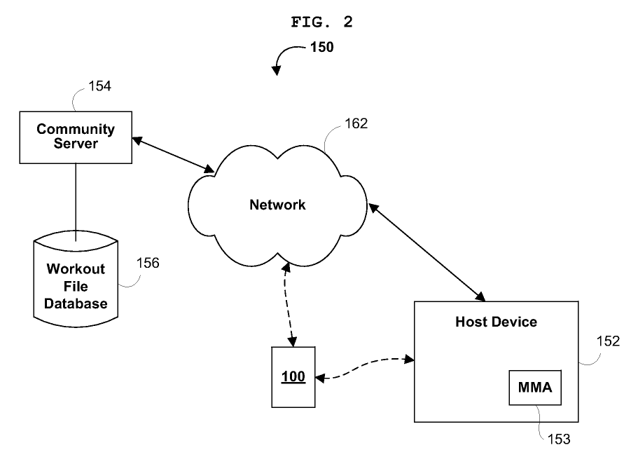

FIG. 2 is a simplified functional block diagram of a distribution system 150 for distributing workout files and other related information according to some embodiments of the invention. System 150 includes electronic device 100, a host device 152 running a media management application (MMA) 153, a community workout server 154, and a workout file database 156, all coupled, either directly or indirectly, to a network 162. In some embodiments, a user of host device 152 can interact with community workout server 154 and download a workout file stored on workout file database 156 via network 162 and save the file to electronic device 100. In other embodiments, the user can generate a workout file during an exercise routine, using the systems and methods described herein, and upload the workout file to community workout server 158 for sharing with other users.

Media management application (MMA) 153 may be configured to manage workout files stored on electronic device 100 or host device 152 and to facilitate browsing, searching, downloading, and/or uploading workout files to and from community workout server 158. One example of a media management application is the iTunes application, available from Apple Computer, Inc. of Cupertino, Calif.

Workout file database 156 may be configured to store workout file information including metadata relating to the workout files available via network 162.

Community server 158 may be configured to provide storage and sharing of information among a community of users. Community server 158 may be implemented in a fashion similar to the Nike+website which allows users to upload certain performance metrics during an iPod sync with iTunes and hosts an online community that allows users to meet and share information. While system 150 shows only one server, those skilled in the art will appreciate that two or more servers may be used without departing from the principles of the invention. For example, a separate store server may be used to manage online purchases or rentals of workout files and other related items and information.

Network 162 may be a high bandwidth network including wired networks, such as the Internet, Ethernet, gigabit Ethernet, and fiber optic, as well as wireless networks such as IEEE 802.11(a), (b) or (g) (WiFi), IEEE (WiMax), and Ultra-Wide Band (UWB). Network 162 can also include wireless networks such as Bluetooth or mobile telephony networks.

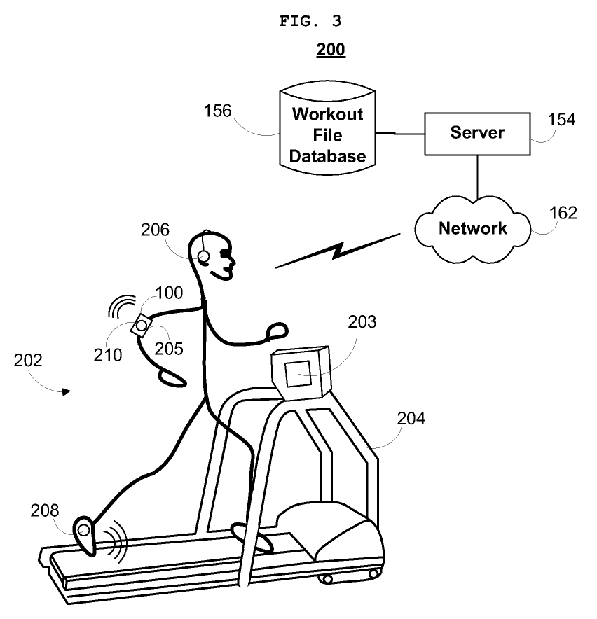

FIG. 3 is a schematic diagram of an exemplary system 200 for providing real-time interaction between a user 202 and a virtual competitor according to some embodiments of the invention. System 200 includes a treadmill 204, a treadmill display 203, an armband 205, a headset 206 coupled to electronic device 100, a sensor 208, a sensor 210 and a network 162 coupled to community workout server 154 and workout file database 156. While system 200 shows several elements communicating wirelessly, those skilled in the art will appreciate that system 200 may be operated with wired connections or a combination of both.

While user 202 runs on treadmill 204, sensor 210 detects physiological data and transmits the information to electronic device 100. Similarly, sensor 208 detects user movements and other non-physiological data and transmits the information to electronic device 100. Electronic device 100 compares the information received from sensors 208 and 210 to that of a virtual competitor and may provide feedback to user 202 in the form of audio or visual cues. Audio or visual cues may be delivered to user 202 by electronic device 100 or transmitted to external media equipment, such as treadmill 204, or by a combination of electronic device 100 and external media equipment. According to some embodiments, feedback delivered to user 202 includes real-time graphics that compare the user's performance metrics to the virtual competitor's performance metrics. The virtual competitor's performance metrics may be derived from a workout file stored on electronic device 100, downloaded from workout file database 156, or streamed from data network 162.

Armband 205, headset 206, and sensors 208 and 210 may be implemented as described in U.S. Patent Application Publication No. 20080076972, entitled “Integrated sensors for tracking performance metrics,” published on Mar. 27, 2008, the entirety of which is incorporated by reference.

Server 154 may communicate with electronic device 100 either wirelessly or over a wired connection. Alternatively, server 154 may communicate with electronic device 100 via treadmill 204. For example, treadmill 204 may be configured to receive data from electronic device 100 and/or server 212 and display, via display 203, real-time graphics that compare the data sets and provide feedback to user 202 during the exercise routine.

Workout files available for download or streaming may include performance metrics associated with a wide range of individuals, distances, and courses. For example, if the exercise routine is running, workout files may include various distances, such as a 5 k, 10 k, half-marathon, marathon or ultra marathon. Workout files may also be associated with a particular course, including famous courses, such as the Dipsea course in Northern California or the Boston Marathon course. In other embodiments, workout files may contain workout data associated with an elite athlete, such as Alberto Salazar, Steve Prefontaine, or Bill Rogers or even current stars like Ryan Hall. In some embodiments, workout files may include data representative of a runner and a course, such as Joan Benoit and her performance at the 1984 Olympic Marathon in Los Angeles.

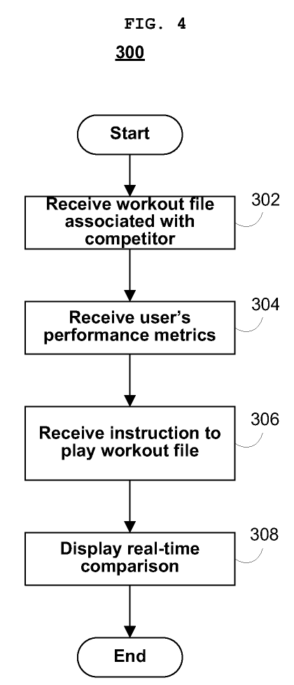

FIG. 4 is a process diagram of an exemplary method 300 for providing real-time interaction between a user performing an exercise routine and a virtual competitor according to some embodiments of the invention. Method 300 begins in step 302 after electronic device 100 receives a workout file. The workout file may be a previous workout performed by user 202 or one of a plurality of workout files available from workout file database 156. For example, user 202, who runs 10 miles on the treadmill everyday, learns by email that, on the previous day, a user 402 ran 10 miles on the treadmill in 53:30, a new health club record. User 202 also learns that user 402 recorded the record-setting run and uploaded a workout file to community server 154. User 202 then uses electronic device 100, or host device 152 via MMA 153, to access server 154. User 202 browses the workout files stored on workout file database 156 and then selects and downloads the workout file associated with the 10-mile run by user 402 and saves it to electronic device 100.

In step 304, as user 202 begins running on treadmill 204 and electronic device 100 receives data indicative of user movements and physiological data via sensors 208 and 210. In some embodiments, electronic device 100 may be configured to indicate that such data is being received.

In step 306, electronic device 100 receives an instruction, such as through user input, to play the workout file selected in step 302. For example, if user 202 inputs an instruction to begin playing the workout file generated by user 402, audio or visual cues may indicate, for example, that the workout has started.

In step 308, the data sets may be analyzed and displayed in real-time to provide user 202 with a comprehensive picture of his or her performance relative to either a previous exercise routine performed by user 202 or one performed by user 402. The output of step 308 may be directed to display 203, a display integrated on electronic device 100, or an external display such as a television monitor available at a health club.

The contents of the display may include any text or graphical design from which user 202 can determine, such as at a glance (e.g., heads up display), whether he or she is ahead of or behind the competitor. According to some embodiments, distances may be displayed either as straight text or with progress bars. If the data sets include GPS data, the display may show the respective positions, such as by using Google Maps. The display may include a graphical rendition of the course associated with the selected workout file. In some embodiments, the course may be shown from the viewpoint of user 202 and may be adjusted in accordance with position information, such as to emulate an actual run on the selected course. For example, if the Boston Marathon course was selected, the display may show a scenery image or virtual landscape of Heartbreak Hill between miles 20 and 21 in which the road stretches in the middle of the display while spectators line the streets and audibly cheer user 202 on, such as through headset 206. In other embodiments, treadmill 204 may be configured to emulate the elevation change of the selected course. For example, treadmill 204 may be configured to emulate Heartbreak Hill, such as by increasing the inclination setting on treadmill 204, causing user 202 to climb 600 meters over 0.4 miles, which is equivalent to climbing Heartbreak Hill.

In other embodiments, media (e.g., audio and/or visual) cues can be provided to the user during the user's performance of activities. Audio and visual cues can include, for example, instructions for the activity, feedback on a user's progress, motivational feedback, and/or entertainment information. The media cues can be played at predetermined points during an activity, based on performance metrics, or at the initiation of the user. Visual cues can include graphical information (e.g., text, still images, and/or videos). Media cues are described in greater detail in U.S. Patent Application Publication No. 20080077620, entitled “Systems and methods for providing audio and visual cues via a portable electronic device,” published on Mar. 27, 2008, the entirety of which is incorporated herein by reference.

For example, as user 202 passes the 2-mile mark, an audible cue played through headset 206 may announce a 2-mile split of 10:27. If user 202 has a lead over user 402, cues may be played if the lead is less than a predetermined distance. For example, if the lead is less than 100 feet, an audible cue may be played, such as “he's right behind you.” For smaller leads, an audible cue may be the sound of footsteps thumping. In other embodiments, the electronic device may be configured to provide tactile feedback, such as a vibration. For example, electronic device 100 may vibrate at each 1-mile split.

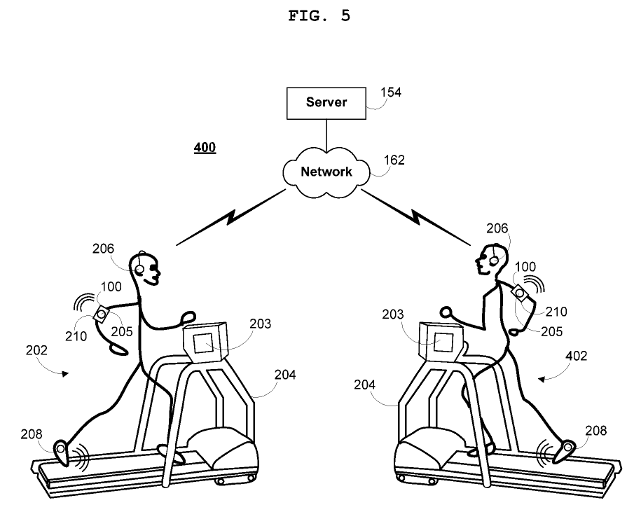

FIG. 5 is a schematic diagram of an exemplary system 400 for providing real-time interaction between two or more users simultaneously performing an exercise routine according to some embodiments of the invention. System 300 is similar in many respects to system 200, except that in system 300 user 202 engages in live competition against user 402 over a network. In some embodiments, user 202 and user 204 may be in remote locations.

While user 202 and user 402 run on respective treadmills 204, performance metrics associated each user are transmitted to server 154 over network 162. Server 154 may be configured to display locally for user 402, graphics associated with the performance metrics of user 202. Likewise, server 154 may be configured to display locally for user 202, graphics associated with the performance metrics of user 402. While system 300 shows only two users, those skilled in the art will appreciate that more users may compete without departing from the principles of the invention.

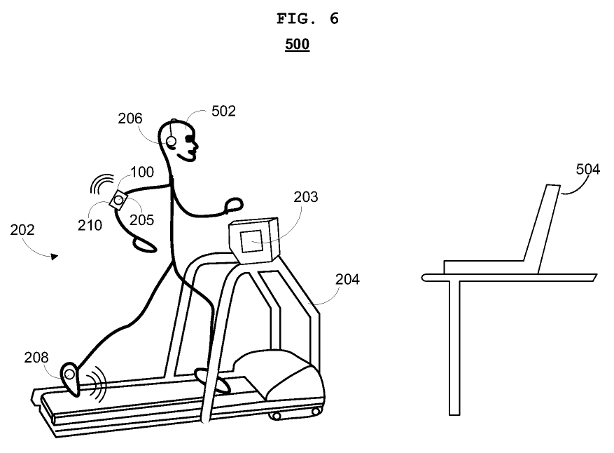

FIG. 6 is a schematic diagram of an exemplary system 500 for playing a game while performing an exercise routine according to some embodiments of the invention. System 500 is similar in many respects to system 200 except that system 500 allows a user 202 to engage in game play while performing an exercise routine by using a hands-free mouse 502 to control a computer 504.

Computer 504 may be configured to create a game environment and to receive and process mouse gestures and performance metrics from user 202, allowing user 202 to play the game.

Hands-free mouse 502 may be implemented using any system that tracks human gestures to control a pointer, such as relative head movements. For example, computer 504 may be a Mac Book equipped with a hands-free software interface to its camera, such as the LaZee Mouse Cursor available from LaZee Tek of Ashley, Ind.

In operation, hands-free mouse 502 may be used to control an avatar that competes with a virtual competitor. The actions of the competitor may be derived from historical workout data generated by the user 202, such as if user 202 recorded and saved a previous workout and then played the workout file in game play mode. Alternatively, the actions of the competitor may be based on historical or live workout data generated by another user, such as user 402. In some embodiments, users can earn points based on their performance against a competitor, which may include a variety of tactical maneuvers controlled by hands-free mouse 502. For example, if the exercise routine is running or cycling, mouse 502 may be used to “crowd” a competitor, forcing the competitor to take a less desirable route. Besides earning points in individual races, system 500 may be used by a community of users to host a series of races in which the runner with the most total points earned in all of the races wins the series.

While the systems and methods described above have been presented in the context of a runner running on a treadmill, principles of the invention are applicable to any other type of exercise routine. For example, embodiments of the invention may be practiced with a variety of indoor fitness equipment including, but not limited to, stationary bicycles, elliptical machines, step machines, and hand cycles. Embodiments of the invention may also include exercise routines performed outdoors, whether or not the user is in the vicinity of a wireless network.

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element is within the scope of the invention.

One of ordinary skill in the art should appreciate that the methods and systems of the present application may be practiced in embodiments other than those described herein. It will be understood that the foregoing is only illustrative of the principles disclosed herein, and that various modifications can be made by those skilled in the art without departing from the scope and spirit of the invention or inventions.

What is claimed is:

1. A portable electronic device for providing real-time interaction between a user performing an exercise routine and a virtual competitor comprising:
a sensor for receiving a plurality of user performance metrics associated with the user;
a processor for generating a comparison between the plurality of user performance metrics and a competitor workout file associated with the virtual competitor; and
a display for displaying a summary of the comparison in real-time.

2. The portable electronic device of claim 1 further comprising a memory for storing the competitor workout file.

3. The portable electronic device of claim 1 further comprising a network interface for receiving the competitor workout file from a remote computer.

4. The portable electronic device of claim 3 wherein the competitor workout is streamed to the network interface during the exercise routine.

5. The portable electronic device of claim 1 wherein the competitor workout file is based on a previous workout performed by the user.

6. The portable electronic device of claim 1 wherein the display includes a virtual landscape.

7. The system of claim 6 wherein the exercise routine is running and the virtual landscape is a road.

8. The system of claim 1 wherein the display shows an avatar corresponding to the user.

9. The system of claim 1 further comprising a network interface for transmitting audio or visual cues to external media equipment.

10. A portable electronic device for providing real-time interaction between a user performing an exercise routine and a virtual competitor comprising:
a network interface for receiving a workout file associated with the virtual competitor and for receiving a plurality of performance metrics associated with the user;
a user input device for receiving an instruction to play the workout file; and
an output module for playing media associated with the plurality of performance metrics associated with the user and the workout file associated with the virtual competitor.

11. The portable electronic device of claim 10 wherein the output module includes audio connector receptacle.

12. The portable electronic device of claim 10 wherein the output module includes a display device.

13. The portable electronic device of claim 10 wherein the output module is configured to play a media cue at a predetermined time during the exercise routine.

14. The portable electronic device of claim 10 wherein the output module is configured to play media including displaying relative positions of the user and the virtual competitor.

15. A web server for facilitating communications among a plurality of electronic devices over a network to implement a real-time interactive application, comprising:
an input module for receiving from a first electronic device a first plurality of performance metrics associated with a first user and for receiving from a second electronic device a second plurality of performance metrics associated with a second user; and
an output module for causing a display associated with the first electronic device to display graphics associated with the second plurality of performance metrics; and for causing a display associated with the second electronic device to display graphics associated with the first plurality of performance metrics.

16. A computer readable medium having stored thereon instructions for facilitating communications among a plurality of electronic devices over a network which, when executed by a processor, cause a processor to perform the steps of:
receiving from a first electronic device a first plurality of performance metrics associated with a first user;
receiving from a second electronic device a second plurality of performance metrics associated with a second user;
causing a display associated with the first electronic device to display graphics associated with the second plurality of performance metrics; and
causing a display associated with the second electronic device to display graphics associated with the first plurality of performance metrics.

17. A portable electronic device for providing interactive game play between a user performing an exercise routine and a virtual competitor comprising:
a sensor input for receiving a plurality of performance metrics associated with the user;
an output module for displaying a user avatar associated with the user and for displaying a competitor avatar associated with the virtual competitor; and
a user input device configured to receive commands to control the user avatar, wherein the competitor avatar is responsive to the movement of the user avatar.

18. The portable electronic device of claim 17 wherein the virtual competitor is derived from a human competitor performing the exercise routine simultaneously with the user.

19. The portable electronic device of claim 18 wherein the virtual competitor is remote from the user.

20. A system for providing interactive game play between a user performing an exercise routine and a virtual competitor comprising:
a portable electronic device configured to detect a plurality of user performance metrics associated with the exercise routine, and wherein the portable electronic device is configured to receive a user input during the exercise routine;
a computer, in communication with the portable electronic device, configured to generate a comparison between the plurality of user performance metrics and a plurality of virtual competitor performance metrics and to display a visualization of the comparison, and wherein the visualization includes an avatar associated with the user, and wherein the avatar is responsive to the user input.
